(19) United States
(12) Patent Application Publication
(10) Pub. No.: US 2014/0202154 A1
(43) Pub. Date: Jul. 24, 2014

(54) RENEWABLE ENERGY SYSTEM

(71) Applicant: Michael R. Tilghman, Phiadelphia, PA (US)

(72) Inventor: Michael R. Tilghman, Phiadelphia, PA (US)

(21) Appl. No.: 14/162,995

(22) Filed: Jan. 24, 2014

Related U.S. Application Data
(60) Provisional application No. 61/756,430, filed on Jan. 24, 2013.

(51) Int. Cl. F03G 6/00

(52) U.S. Cl. CPC F03G 6/001
USPC 60/641.15

(57) ABSTRACT

An integrated renewable energy system is provided for a tall multi-story building including solar, wind, and hydrogen subsystems. The solar subsystem includes a plurality of photovoltaic panels to produce a first source of electrical energy and a concentrated solar thermal system for producing a second source of electrical energy. The concentrated solar thermal system includes plurality of directional mirrors operative to concentrate solar energy onto a plurality of stream producing vessels and a turbine generator operative to receive steam expanded from the vessels to drive a turbine of the generator. The wind subsystem includes at least one wind turbine to produce a third source of electrical energy. The hydrogen subsystem includes an artificial photosynthesis (photoelectrolysis) system for producing hydrogen and a fuel cell receiving the hydrogen for producing a fourth source of electrical energy through reverse hydrolysis. The artificial photosynthesis (photoelectrolysis) system receives one of the first, second and third sources of electrical current to separate hydrogen from a hydrogen-based fluid (water H 2 O) to produce a supply of hydrogen. The hydrogen subsystem also includes a containment system for storing the hydrogen for subsequent use by the fuel cell.

### FIELD

The aspects of the disclosed embodiments are directed to renewable energy resources for commercial and residential buildings and, more particularly, to a new and useful building structure which integrates multiple renewable energy resources to enable complete off-grid power during peak hours of demand.

### BACKGROUND

As the cost of fuel, i.e., oil, nuclear, coal, and natural gas, has steadily increased over the past several years, a greater emphasis has been placed on renewable energy resources in commercial and residential buildings as a means to offset the escalating cost of fuel, and mitigate power disruptions due to storms and brownouts. Such renewable sources of energy offer the further benefit of mitigating a reliance on foreign sources of fossil fuels along with the political and social turmoil oftentimes influencing the price volatility and availability of such fuels. The prior art sources of renewable energy have principally relied on solar, wind or a combination of solar and wind powered systems to augment energy provided by a central power grid employing non-renewable energy sources, such as petroleum, natural gas or coal, to produce electrical power. While such renewable sources of energy have provided a degree of relief from non-renewable sources, there has not, as yet, been a satisfactory solution for a building structure, which is fully powered by one or more renewable energy resources.

Accordingly, it would be advantageous to provide a non-explosive permanent isolation valve for spacecraft fluid systems that overcomes the problems described above.

### BRIEF DESCRIPTION OF THE DISCLOSED EMBODIMENTS

As described herein, the exemplary embodiments overcome one or more of the above or other disadvantages known in the art.

One aspect of the exemplary embodiments relates to an integrated renewable energy system is provided for a tall multi-story building including solar, wind, and hydrogen subsystems. The solar subsystem includes a plurality of photovoltaic panels/glass to produce a first source of electrical energy and a concentrated solar thermal system for producing a second source of electrical energy.

The concentrated solar thermal system includes plurality of directional mirrors operative to concentrate solar energy onto a plurality of steam producing vessels and a turbine generator operative to receive steam expanded from the vessels to drive a turbine of the generator. The wind subsystem includes at least one wind turbine to produce a third source of electrical energy. The hydrogen subsystem includes an artificial photosynthesis (photoelectrolysis) system for producing hydrogen and a solid oxide fuel cell (SOFC) System receiving the hydrogen for producing a fourth source of electrical energy through hydrolysis. The SOFC waste heat, roughly 1,000 degrees C., will be used to power a micro steam generator. The artificial photosynthesis (photoelectrolysis) system receives one of the first, second and third sources of electrical current to separate hydrogen from a hydrogen-based fluid (water H2O) to produce a supply of hydrogen. The hydrogen fuel subsystem further includes a containment system for storing the hydrogen for subsequent use by the fuel cell system

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the present disclosure, and together with the general description given above and the detailed description given below, serve to explain the principles of the present disclosure. As shown throughout the drawings, like reference numerals designate like or corresponding parts.

FIG. 1 is a schematic view of one embodiment o f a multi-story building incorporating aspects of the present disclosure, powered by an integrated system of renewable energy resources including solar, wind and hydrogen fuel subsystems.

FIG. 2 is an enlarged schematic view of the uppermost portion of the building/tower of FIG. 1 depicting the solar and wind subsystems in greater detail.

FIG. 3 is a schematic view of the solar subsystem of the integrated renewable energy system according to an embodiment of the present disclosure.

FIG. 4 is a schematic view of the wind subsystem of the integrated renewable energy system according to an embodiment of the present disclosure.

FIG. 5 is a schematic view of the hydrogen fuel subsystem of the integrated renewable energy system according to an embodiment of the present disclosure.

FIG. 6 illustrates one embodiment of an artificial photosynthesis or photoelectrolysis process for a building incorporating aspects of the disclosed embodiments.

### DETAILED DESCRIPTION OF THE EXEMPLARY EMBODIMENTS OF THE DISCLOSURE

Referring to FIG. 1, the aspects of the present disclosure are directed to a system for powering tall multi-story structures, i.e., commercial office and/or residential buildings, by an integrated compliment of renewable energy resources. As is illustrate d in Figure 1, a system is employed to power an office/residential building 20 (hereinafter referred to as the “tower”) standing over, for example, about three thousand feet (3300 ft.) in elevation and includes a solar subsystem 100, a wind subsystem 200 and a hydrogen fuel subsystem 300

In accordance with the aspects of the present disclosure, the primary energy source of the building 20 will be electric. As is shown in the embodiment of FIGS. 1-3, the solar subsystem 100 includes a plurality of photovoltaic panels 102 disposed along the exterior walls of the tower 20. In one embodiment, the panels 102 form an exterior solar curtain wall, generally indicated by reference 104. In one embodiment, the photovoltaic glass/panels 102 or curtain wall 104 are configured to produce direct current in the presence of sunlight, which is converted to alternating current by a DC-AC converter 106. This source of electrical energy is a principle or first source Si during hours of peak electricity demand.

In the preferred embodiment, the panels 102 are disposed along/cover the exterior walls of the tower 20 on the uppermost portion thereof, i.e., at an elevation, which is essentially unobstructed by adjacent buildings/structures. Accordingly, a system 1 0 may employ photovoltaic panels 102 along the exterior walls of the uppermost portion (i.e., upper 2000 feet) of the tower 20 to prevent solar energy from being shadowed by adjacent structures standing below this elevation (i.e., the lowermost 1000 feet).

In one embodiment, the curtain wall 104 of photovoltaic panels 102 will facilitate approximately 56 acres or 2.4 million square feet of transparent photovoltaic glass panels. The entire curtain wall 104 can form a vertical solar farm that can be disposed approximately 1 km above the ground level, with direct solar or photonic exposure from all directions, such as east, south, north and west. In one embodiment, specialized windows can be used in the building 20, such as transparent photovoltaic glass windows that are several times the efficiency of leading conventional solar panels. The solar transparent glass panels will collect photons through microcells embedded in the glass. The microcells can rapidly and efficiently transfer the photonic energy to electric semiconductor conduits in the curtain wall frame down to a central collection unit where the solar energy will be inverted into an AC supply and trifurcated into three main functions. These functions include providing a direct current (DC inverted to AC) supply to building energy load demands, utilization of a Concentrated Solar Thermal (CST) system, using the concentrated sun's rays on liquid contained in tubes to be heated at very high temperatures that produce steam to power steam-turbine generator and producing hydrogen through artificial photosynthesis (photoelectrolysis) for fuel cell generation and storage for intermittent supply.

In one embodiment, the specialized windows can cover all or only a portion of the building 20. In one example, windows can cover from for example, the 30^{th} floor to the top of the building 20. In alternate embodiments, the windows can be situated along any suitable portion of the building 20 that captures sun energy.

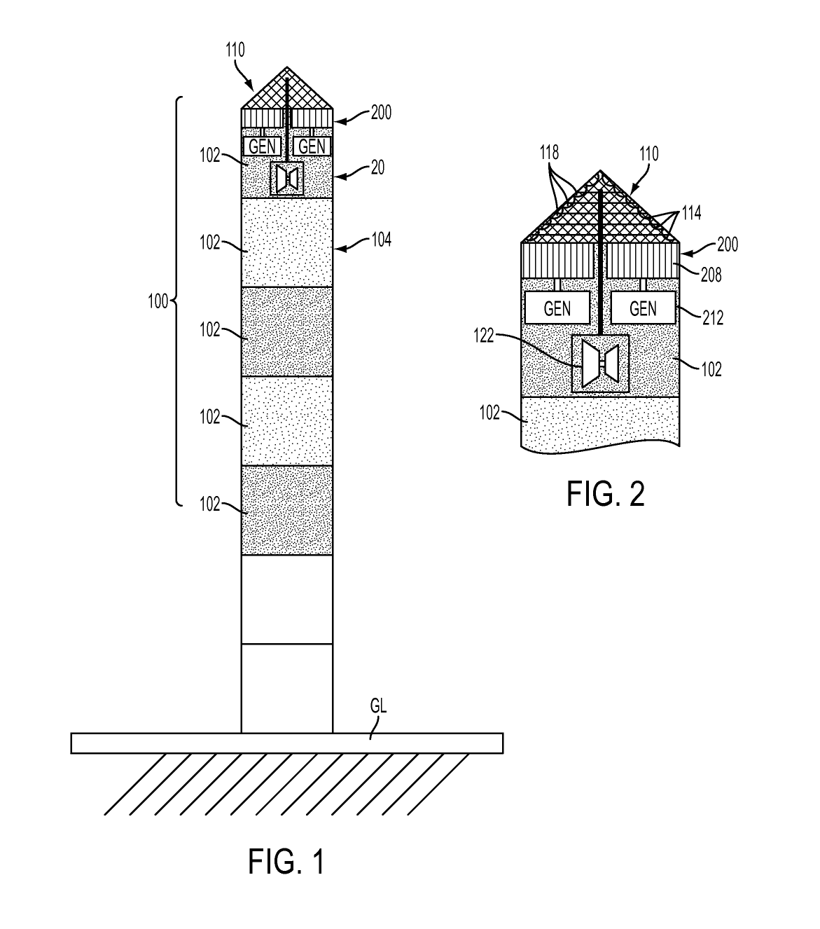

In the example of FIGS. 1 and 2, the solar subsystem 100 also includes a solar-powered steam turbine 110 or Concentrated Solar Thermal (CST) system. In one embodiment, the solar powered steam turbine 110 is configured to provide a second source S2 of electrical energy. Solar energy is also intermittent energy with dubious claims of being effective after sunset. The thermodynamics of solar (PV) energy is very powerful and effective. The functionality of the cogeneration utilizing heat can provide adequate storage and building operations functionality. Solar rays can create intense heat by using mirrors to heat liquid contained in tubes (CST). The solar heated liquid, combined with the SOFC waste heat, is used to boil water and create steam, which in turn can power a steam-turbine generator, and be used as domestic heat and hot water source. The storage is used by molten salt tanks that hold and store 40% of the heat created by the plant. These storage tanks will be so efficient they will be able to store enough heat to run 8-18 hours steam generation without additional sunlight. Moreover, these tanks have thermal efficiencies up to 95%-96% of supply.

In one embodiment, the solar powered steam turbine 110 includes a plurality of directional mirrors 114 (see FIG. 2) operative to concentrate solar energy onto a plurality of steam producing vessels 118. The steam contained in the vessels 118 is expanded through a turbine generator 122 to produce the second source S2 of electrical energy. In one embodiment, the second source S2 is configured to augment the first source S1 of electrical power to satisfy the energy requirements of the tower 20 during peak hours of demand.

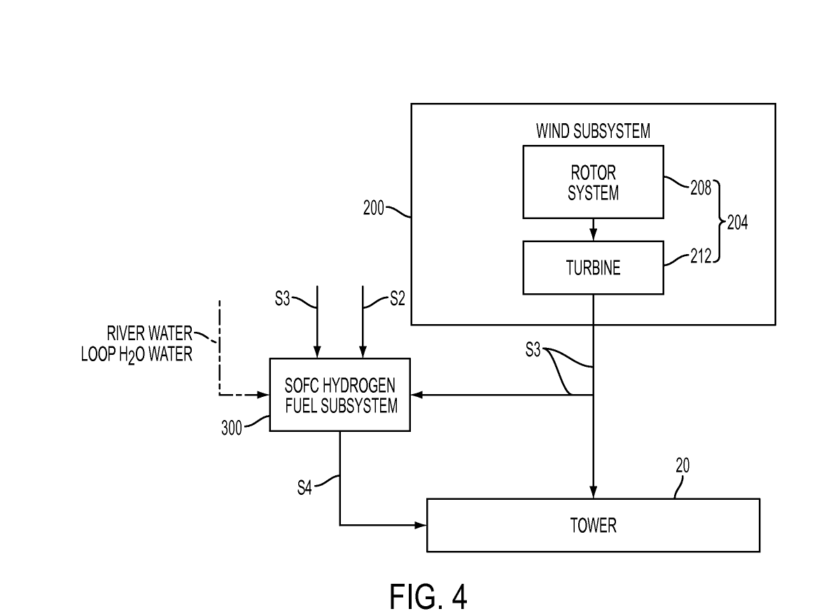

As illustrated in FIGS. 1, 2 and 4, the wind subsystem 200 employs one or more wind turbines 204. Wind generation can be used as a supplemental source of electrical energy when optimal usage of the photovoltaic curtain wall 104 cannot be obtained, such as when there is inclement or cloudy weather, or during evening and night hours. The wind bifurcated energy supply functions of the wind subsystem 200 generally includes providing direct current (DC inverted to AC) supply to building energy demand and producing storage hydrogen (H2) through Artificial Photosynthesis (photoelectrolysis) for fuel cell generation. In one embodiment, each wind turbine 204 can be configured to produce 5-7 megawatts of electricity.

The wind turbines 204 can generally disposed at inconspicuous locations along the exterior of the tower 20. Preferably, the wind turbines 204 are disposed at an elevation at or above which winds are sustained to drive the wind turbines 204. Generally, sustained winds are present at altitudes above ground level (GL).

For example, a building or superstructure 20 that is approximately 1 kilometer (3,300 feet) tall can capture more wind energy by tapping sustained wind currents at approximately 400 meters (1,700 ft) above the ground level. Hence, the wind turbines 204 should preferably be disposed on the tower 20 at altitudes exceeding this elevation. This constant wind stream, combined with the cube tubular design of the building structure 20, will also create effective sustained wind vortexes that can expand the wind collection beyond 5-7 megawatts of projected wind harvest. In one embodiment, the wind turbines 204 will each generate approximately 5-7 megawatts of electrical power.

In one embodiment, the wind turbines 204 may include a conventional propeller type or centrifugal rotor system 208 for capturing wind energy. In accordance with the aspects of the present disclosure depicted in the figures, a pair of centrifugal rotor systems are disposed at an uppermost portion of the tower 20. The rotor system 208 drives a conventional turbine generator 212 which produces yet another source, i.e., a third source S3, of electrical energy. The energy produced is direct current (DC) which is converted to alternating current (AC) by a conventional DC-AC converter 206. While the third source S3 of electrical energy may be used to augment the primary sources, i.e., the sources S1, S2 produced by the solar subsystem 100, the third source S3 can be a secondary source of energy for the tower 20. That is, the third source S3 of electrical energy from the wind subsystem 200 is available when ambient conditions do not permit the generation of electrical energy by the solar subsystem 100.

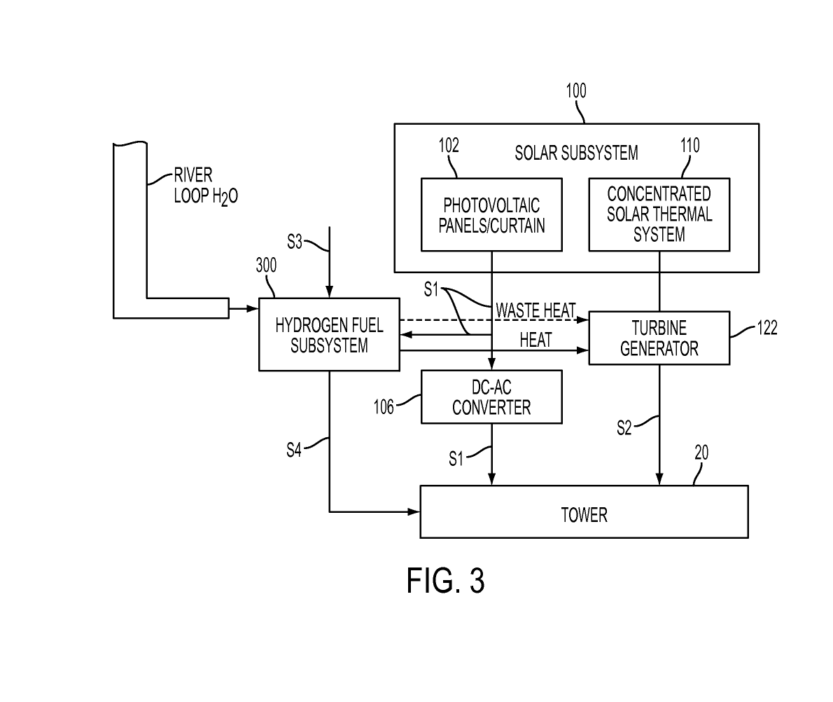

When all power requirements of the tower 20 are met by either the solar or wind subsystems 100, 200, excess energy may be harnessed and stored by the hydrogen fuel subsystem 300 illustrated in FIG. 3. More specifically, excess energy of the solar and wind subsystems 100, 200 may be captured by producing a supply of hydrogen which may then be used to produce another or fourth source S4 of electrical energy. This fourth source S4, generally referred to as a specialized fuel cell system, will principally be used during low-energy ambient conditions, i.e., when a cloud cover impedes sunlight and/or when solar and wind conditions are non-optimum.

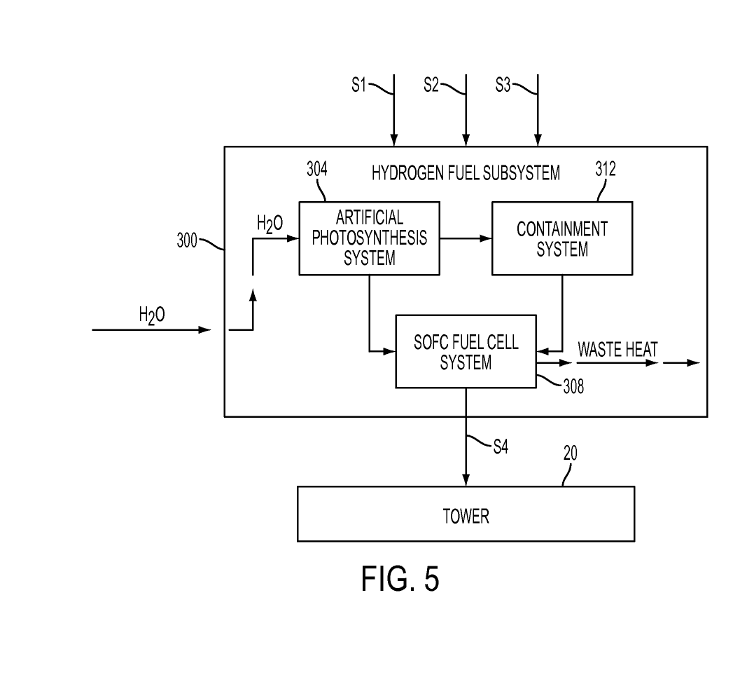

There are highly developed SOFCs currently in production that can be powered by hydrogen (H2) produced by the aforementioned (wind and solar) through Artificial photosynthesis (photoelectrolysis) and effectively supply the balance of the building's electric demand during peak demand and off-hours. Referring to FIG. 5, the hydrogen fuel cell system 300 works synergistically with the trifurcated functionality of the solar/photonic collection, and bifurcated functions of the wind generation. In one embodiment, the wind and solar energy is collected and utilized to support the building's operations and serves as an ignition to a central fuel cell unit by converting the solar/wind energy to stored hydrogen through hydrolysis.

The fuel cell system 300 collects excess energy and converts water to hydrogen from the solar and wind units 100, 200, stores that energy locally, then running that hydrogen in reverse to supply for intermittency when solar and/or wind cannot be utilized. Examples include, evenings, cloudy or rainy conditions.

A main concern with the development of renewable energy is the effective use of adequate storage of intermittent energy sources such as wind and solar. Hydrogen energy converted by wind and solar, through artificial photosynthesis (photoelectrolysis), is a very effective source of energy that does not emit carbon dioxide in the environment. Hydrogen storage has been studied for mobile applications for cars, boats, and the like. The challenges for mobile applications have been hydrogen/energy density issues which question the loss factor of such storage and the overall use of hydrogen as a fuel. Unlike mobile applications, hydrogen/energy density is not a major problem for stationary application such as this off-grid localized building integrated renewable energy concept. There are established technologies that exist for hydrogen storage that would make the use of hydrogen storage, and consumption in this building concept very safe and practical. The storage applications for hydrogen include, for example, slush hydrogen in a cryogenic hydrogen tank, compressed hydrogen (CGH2) in a hydrogen tank, and liquid hydrogen in a (LH2) cryogenic hydrogen tank.

Utilizing the excess energy in the form of stored hydrogen, the hydrogen fuel cell unit 300 is able to produce its own electric energy at a rate of several times the amount of what is collected and stored from the other two sources 100, 200. That energy is then used to support the balance of the building's functions when the solar and wind systems 100, 200 are not at optimum production levels.

SOFCs produce up to 1000-degrees C of waste heat. The waste heat can be harnessed and used to propel a steam turbine. This efficiency view is similar to a Combined Cycle natural gas power plant.

In the example illustrated in FIGS. 1 and 5, in one embodiment, the hydrogen fuel subsystem 300 includes an artificial photosynthetic system 304 disposed in combination with a fuel cell system 300. The artificial photosynthesis (photoelectrolysis) system 304 utilizes excess energy produced by the solar and wind subsystems 100, 200 to produce and store the supply of hydrogen in a containment system 312. More specifically, the artificial photosynthesis (photoelectrolysis) system 304 produces hydrogen by a process that converts sunlight and water into hydrogen and oxygen. The containment system 312 is configured to store the hydrogen produced by the artificial photosynthesis (photoelectrolysis) system 304 and may include cryogenic hydrogen tanks for storing a supply of slush or liquid hydrogen. Alternatively, the hydrogen tanks may contain a supply of compressed hydrogen.

The fuel cell system (SOFCs) 308 shown in FIG. 5 receives the supply of hydrogen through a process of reverse hydrolysis. Additionally, SOFC waste heat is used to increase thermal production to the concentrated solar thermal system that produces the fourth source S4 of electrical energy. As mentioned above, this source S4 will be used principally when the energy produced by the solar and wind subsystems 100, 200 are inadequate to meet the energy requirements of the tower 20. In one embodiment, the excess heat from SOFCs and CST can be used to supply domestic heat and hot water.

In another embodiment of the present disclosure, rather than, or in addition to, excess electrical energy being used to produce hydrogen for the hydrogen fuel subsystem 300, such excess electrical energy may be returned to the power grid during peak hours of demand. As such, in one embodiment, electrical energy may be sold back to the grid at a favorable rate or used to power neighboring buildings in a micro grid format.

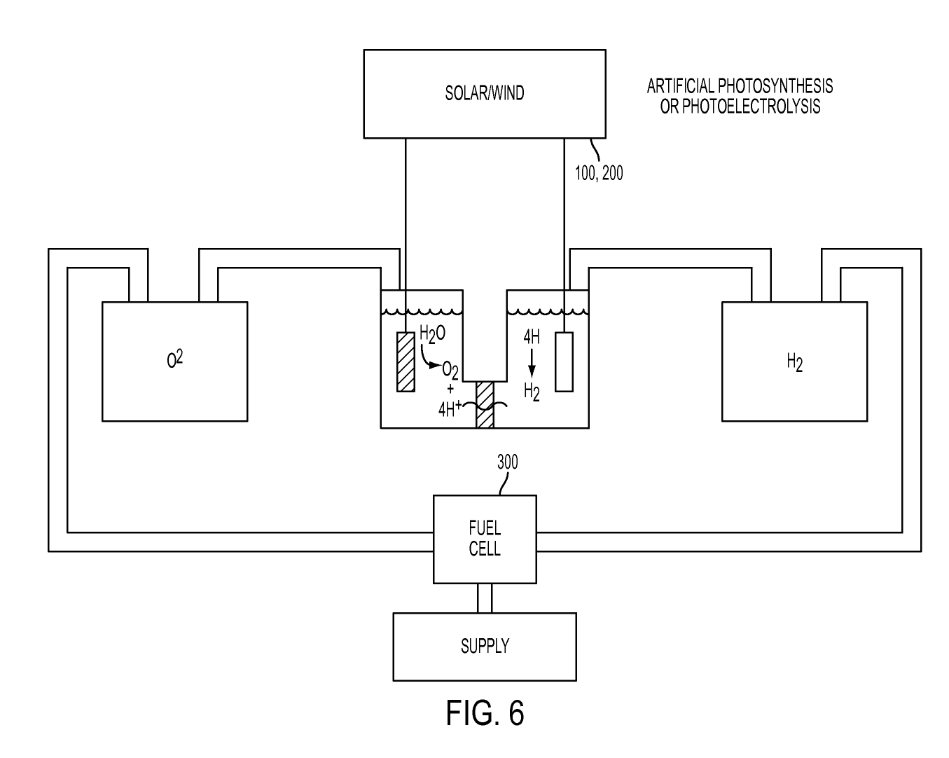

Referring to FIG. 6, one embodiment of the artificial photosynthesis or photoelectrolysis system or a process for a structure incorporating aspects of the disclosed embodiments is illustrated.

The aspects of the present disclosure provide an integrated renewable energy system that includes solar, wind and hydrogen fuel subsystems for providing energy and power in a self-sustaining manner, also referred to as an off-grid energy sustaining building. The aspects of the present disclosure are directed to providing a 100% Building Integrated Renewable Energy sustainable building. 100% Renewable Energy Sustainable is generally defined by the building's ability to supply the building's energy demands by producing 100% renewable energy by utilizing the building's renewable energy multi-generating/storage components. From the Photovoltaic Curtain Wall 104, Wind Turbines 200, specialized Fuel Cells Units 300 with reverse hydrogen storage, the aspects of the disclosed embodiments are able to support the building operations and energy demands on a 24-hour basis 7 days a week, 365 days per annum without the need for electricity/natural gas/steam supplied by a third-party energy company.

These multi-components are tied to inexhaustible energy sources, such as Solar (photonic or photovoltaic), wind, water (H2O) and fuel cells, where renewable energy can be harvested on site. The building will employ 100% off-grid building integrated renewable energy, generating power from a photovoltaic curtain wall, wind building integrated turbines, and specialized solid oxide fuel cells (SOFC) fuel cell systems that work synergistically with specialized hydrogen flow energy storage units. The renewable energy components will be configured to work together simultaneously to supply the building's energy load, and provide continuous uninterrupted power supply without occupant operational requirements. The building will be on the cutting edge of technology in mechanical design to achieve the highest degree of operations efficiency and structural integrity.

Thus, while there have been shown, described and pointed out, fundamental novel features of the invention as applied to the exemplary embodiments thereof, it will be understood that various omissions and substitutions and changes in the form and details of devices and methods illustrated, and in their operation, may be made by those skilled in the art without departing from the spirit of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An integrated system of renewable energy useful for powering a tall multi-story building, comprising:
a solar subsystem including a plurality of photovoltaic curtain wall to produce a first source of electric energy, and a concentrated solar thermal system to produce a second source of electrical energy, the concentrated solar thermal system including plurality of directional mirrors operative to concentrate solar energy onto a plurality of steam producing vessels and a turbine generator operative to receive steam expanded from the vessels to drive a turbine portion of the generator;
a wind subsystem including at least one wind turbine operative to produce a third source of electrical energy,
a hydrogen fuel subsystem including an artificial photosynthesis (photoelectrolysis) system for producing hydrogen and a fuel cell for receiving the hydrogen to produce a fourth source of electrical energy through reverse hydrolysis, the artificial photosynthesis (photoelectrolysis) system receiving one of the first, second and third sources of electrical current to separate hydrogen from a hydrogen-based fluid to produce a supply of hydrogen and storing the hydrogen in a hydrogen containment system.

2. The system according to claim 1 wherein the photovoltaic panels are disposed along the exterior walls of at least the uppermost portion of the tall multi-story building.

3. The system according to claim 2 wherein the wind turbine subsystem includes a plurality of wind turbines disposed at various elevations along the exterior of the multi-story building.

4. The system according to claim 1 wherein the first and second sources of electrical energy from the solar subsystem are the principle source of electrical energy for powering the multi-story building.

5. The system according to claim 4 wherein the third source of electrical energy from the wind subsystem is a secondary source of electrical energy for powering the multi-story building.

6. The system according to claim 5 wherein the fourth source of electrical energy from the hydrogen fuel subsystem is a tertiary source of electrical energy for powering the multi-story building.

7. The system according to claim 1 wherein the containment system includes a hydrogen tank for storing slush hydrogen.

8. The system according to claim 1 wherein the containment system includes a hydrogen tank for storing liquid hydrogen.

9. The system according to claim 1 wherein the containment system comprises a hydrogen tank for storing compressed hydrogen.

10. The system according to claim 1 wherein electrical energy produced by the solar and wind subsystems is returned to a power grid during peak hours of demand and wherein electrical energy is received by the hydrogen fuel subsystem from the power grid during periods of low demand to produce hydrogen for the fuel-cell system.
